(19) United States
(12) Patent Application Publication
(10) Pub. No.: US 2025/0239602 A1
(43) Pub. Date: Jul. 24, 2025

(54) LI ION PRODUCT FOR ACCESSIBLE ENERGY DENSITY OPTIMIZATION

(71) Applicant: PRIYADARSHI PANDA, SUNNYVALE, CA (US)

(72) Inventor: PRIYADARSHI PANDA, SUNNYVALE, CA (US)

(21) Appl. No.: 18/419,556

(22) Filed: Jan. 23, 2024

(51) Int. Cl. H01M 4/525; H01M 4/02; H01M 4/04; H01M 4/1391; H01M 4/1397; H01M 4/505; H01M 4/58; H01M 4/62; H01M 4/66; H01M 10/058; H01M 10/42; H01M 10/44

(52) U.S. Cl. CPC H01M 4/525; H01M 4/0404; H01M 4/043; H01M 4/1391; H01M 4/1397; H01M 4/505; H01M 4/5825; H01M 4/623; H01M 4/625; H01M 4/661; H01M 10/058; H01M 10/446; H01M 2004/028; H01M 2010/4292

(57) ABSTRACT

In one aspect, a method for Li ion product for accessible energy density optimization, comprising: providing a cathode active material; optimizing a cathode aerial density between for a high C-rate energy density retention; optimizing a cathode thickness during a post pressing for the high C-rate energy capacity and energy density retention; optimizing an N:P ratio the anode for the high C-rate energy and energy density retention; optimizing a loading for the high C-rate energy and energy density retention of a cathode mixture slurry solids; optimizing a cathode electrode wet thickness post coating for the high C-rate energy and energy density retention; and optimizing a cathode thickness post drying in a coat and a dry oven for the high C-rate energy and energy density retention.

### BACKGROUND

The research and development in Li ion cells have focused on developing cells with higher energy densities which should ensure longer driving range for electric vehicles. However, for standard use cases where fast charging is deployed, the fundamental energy of cells cannot be accessed leading to sub optimal range being provided by electric vehicles. With wider adoption of EVs and democratized charging networks, the world is moving towards faster charging and high C-rate operations. The new expectation is to have electric vehicles which provide higher safety, higher stability and higher cycle life (e.g. warranty and total cost of ownership). The current work focuses on exploring the space of optimized behavior at high C-rates. It is shown that to gain better stability and safety of the Li ion cells powering the EVs as well as higher cycle life, the design of the cell components (e.g. electrodes) is optimized which leads to a reduction in the fundamental energy density. However, for standardized use cases of 1 C-1 C or 1.5 C-1.5 C, the accessible energy density for these Li ion cells optimized for high C-rate behavior is comparable to cutting edge cells while providing all other benefits missing from cutting edge Li ion cells focused on providing the maximum fundamental energy density at the cost of stability, safety and cycle life. The work will help proliferate Li ion cells with different characteristics, more suited for mass adoption in hot climates as well as for long lifetime (e.g. long warranty) EV for mass adoption.

### SUMMARY OF THE INVENTION

In one aspect, a method for Li ion product for accessible energy density optimization, comprising: providing a cathode active material; optimizing a cathode aerial density between for a high C-rate energy density retention; optimizing a cathode thickness during a post pressing for the high C-rate energy capacity and energy density retention; optimizing an N:P ratio the anode for the high C-rate energy and energy density retention; optimizing a loading for the high C-rate energy and energy density retention of a cathode mixture slurry solids; optimizing a cathode electrode wet thickness post coating for the high C-rate energy and energy density retention; and optimizing a cathode thickness post drying in a coat and a dry oven for the high C-rate energy and energy density retention.

In another aspect, a method for Li ion product for accessible energy density optimization comprising: providing a mixture of cathode active material (CAM) with an active carbon, an NMP solvent and a suitable binder such as PVDF (Poly Vinyl Di-Fluoride) is mixed in a proportion of solids to liquids ratio of 65-95%; coating a mixed cathode slurry is coated on an Aluminum foil of thickness of 8-15 um at thickness of 210-330 um; drying a wet electrode is dried in a 5×2 m oven with a temperatures between 100-130° C. to evaporate the slurry; compressing the dried electrode using a pressing equipment with two (2) rolls; pairing the pressed electrode with anode electrode consisting of an arial density and thickness to ensure an N:P ratio of 1.05-1.2; and winding the electrode pairs with an industry standard separator (e.g. ceramic) or any other with jelly roll turns of 17-21 and thickness from 11-14 mm followed by a combination of two (2) jelly rolls connected with current collectors on a lid assembly through an ultrasonic or any other welding method followed by wrapping in an insulator wrap and the two jelly roll insulator wrapped active material placed in a prismatic can and the lid assembly being welded to the prismatic can via laser welding or any other welding method.

### BRIEF DESCRIPTION OF THE DRAWINGS

FIG. 1 illustrates an example process for optimizing the high C-rate behavior (capacity retention and subsequently accessible energy density) of a Li ion Product, according to some embodiments.

FIG. 2 illustrates an example process of a wide-body example, according to some embodiments.

FIGS. 3A-B illustrate an example process for Li ion product for accessible energy density optimization, according to some embodiments.

FIG. 4 illustrates an example table showing C-rate behavior for one embodiment at CC-CV charging for different charge rates from 3-4.2V CC followed by 0.05 C current in CV mode, according to some embodiments.

FIG. 5 illustrates an example table showing C-rate behavior for one embodiment at CC discharge for different discharge rates from 4.2-3.0V, according to some embodiments.

FIG. 6 illustrates an example table showing the accessible energy for standard charge-discharge at different rates with charge at CC-CV charging for different charge rates from 3-4.2V CC followed by 0.05 C current in CV mode and discharge from 4.2-3.0V at different discharge rates, according to some embodiments.

FIG. 7 illustrates an example charge-discharge capacity retention at different C-rates for typical high fundamental energy density NMC/LFP cells, according to some published literature.

FIG. 8 illustrates an example table showing the accessible energy for standard charge-discharge at different rates with charge at CC-CV charging for different charge rates from 3-4.2V CC followed by 0.05 C current in CV mode and discharge from 4.2-3.0V at different discharge rates for a standard NMC-811 cylindrical 2170 cell, according to some published literature.

FIG. 9 illustrates an example plot showing accessible energy density changes with C-rate increases for optimized Li ion cells per some embodiments as compared with standard published literature for standard Li ion cells not optimized for high C-rate capacity retention.

The Figures described above are a representative set and are not an exhaustive with respect to embodying the invention.

### DESCRIPTION

Disclosed are a system and method for an Li ion product for accessible energy density optimization through maximized capacity retention at high C-rates. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Cathode is the electrode from which a conventional current leaves a polarized electrical device.

C-rate can be the charge and/or discharge current divided by a battery's capacity to store an electrical charge.

Lithium nickel manganese cobalt oxides (abbreviated Li-NMC or NMC) are mixed metal oxides of lithium, nickel, manganese, and cobalt. They have the general formula LiNiₓMn_{y}Co_{z}O₂. The most important representatives have a composition with x+y+z that is near 1, with a small amount of lithium on the transition metal site. NMCs can be used on a positive side, which acts as the cathode during charge-discharge.

Lithium-ion (Li ion) product can use the reversible intercalation of Li+ ions into electronically conducting solids to store energy. The general architecture involves a cathode and anode electrode, a separator to separate the two electrodes electrically and an electrolyte solution for Li ions to flow through from cathode to anode electrode during charging and from anode to cathode electrode during discharging

N/P ratio (e.g. of a negative to positive electrode capacity (N/P)) of a lithium-ion battery can be a parameter for managing battery performance and safety.

Prismatic cell can be a cell with the active material chemistry enclosed in a rigid non cylindrical casing made of metal or metal alloys.

C-rate tests for charging are carried by cycling a Li ion cell from 3-4.2V in CC mode followed by current degradation to 0.05 C in CV mode at 4.2V and checking the energy capacity at cycling rates of C/5, C/2, 1 C and 2 C sequentially. This process is repeated 3 times for each cycling rate of C/5, C/2, 1 C and 2 C to ensure the same energy capacity during the 3 repeats.

C-rate tests for discharging are carried by cycling a Li ion cell from 4.2-3.0V in CC mode and checking the energy capacity at cycling rates of C/5, C/2, 1 C and 2 C sequentially. This process is repeated 3 times for each cycling rate of C/5, C/2, 1 C and 2 C to ensure the same energy capacity during the 3 repeats.

Capacity retention can be defined as the amount of energy accessed during a particular C-rate process such as at C/5, C/2, 1 C or 2 C cycling. Percentage capacity retention or accessible capacity retention is defined as the capacity at a certain C-rate such as C/5, C/2, 1 C or 2 C as a fraction of the capacity at the slow C/5 C-rate cycling condition

### Example Methods

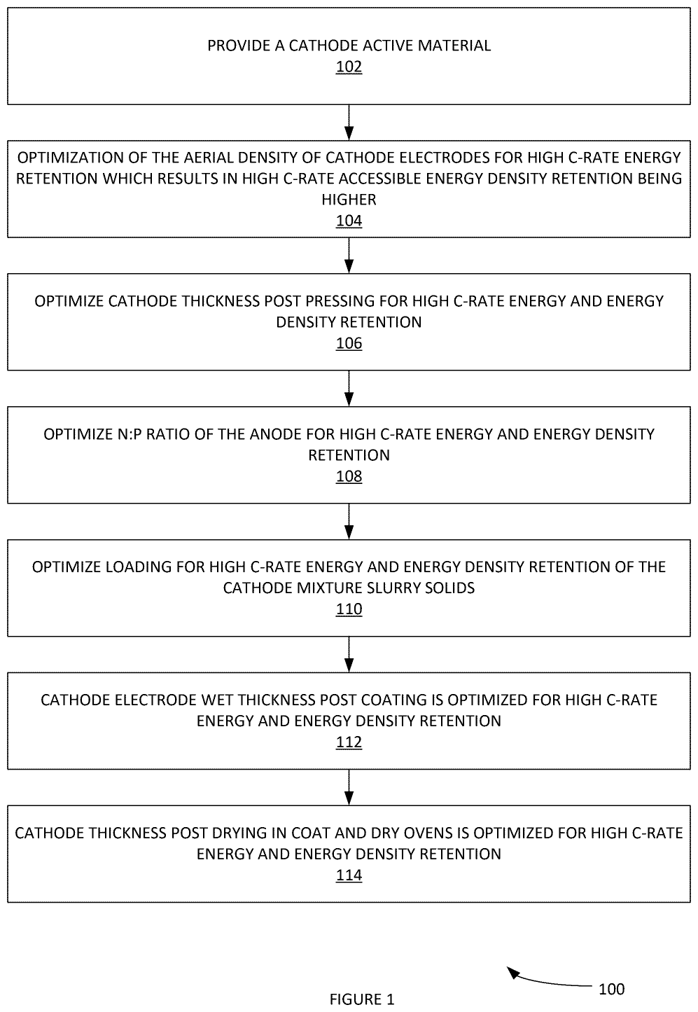

FIG. 1 illustrates an example process 100 for optimizing the high C-rate (Fast Charge-Discharge) of a Li ion Product, according to some embodiments. In step 102 process 100 provides a cathode active material. This can be NMC-111 or NMC-532 or NMC-622 or NMC-811 or NMC-9.5.5 or any other variant of NMC chemistry (NxMyCz) or any other cathode active material chemistry such as LFP (Lithium Iron Phosphate), LMFP (Lithium-Manganese-Iron-Phosphate), LCO (Lithium Cobalt Oxide), LMnO (Lithium Manganese Oxide). In step 104, process 100 optimizes the cathode aerial density between for high C-rate energy density retention which subsequently results in higher accessible or useable energy density experienced by users using the Li ion cells or batteries made using these Li ion cells thereof.

In step 106, process 100 optimizes the cathode thickness (e.g. foil and active material) post pressing for high C-rate energy capacity and energy density retention. In step 108, process 100 optimizes the N:P ratio the anode for high C-rate energy and energy density retention. In step 110, process 100, optimizes the loading for high C-rate energy and energy density retention of the cathode mixture slurry solids. In step 112, the cathode electrode wet thickness post coating is optimized for high C-rate energy and energy density retention. In step 114, the cathode thickness post drying in coat and dry ovens is optimized for high C-rate energy and energy density retention.

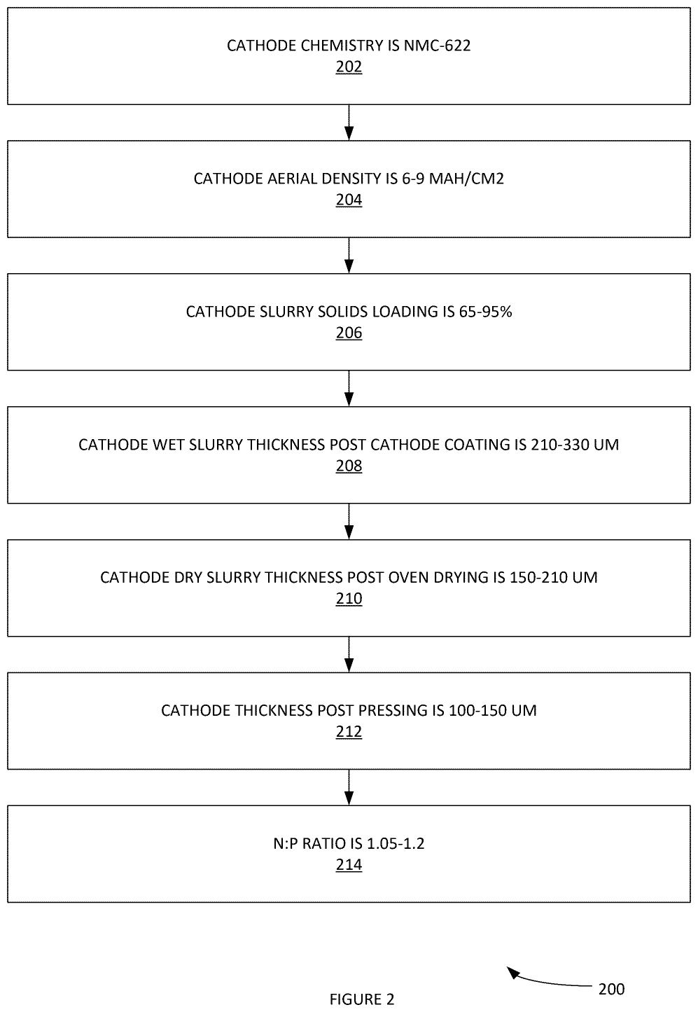

FIG. 2 illustrates an example process 200 of a wide-body example, according to some embodiments which describes the optimization process of the product components to enable to high C-rate useable energy and energy density characteristics. In step 202, a cathode chemistry can be NMC-622. In step 204, a cathode aerial density is 6-9 mAh/cm2 which allows for low density conditions and better access to Lithium during high C-rate (>1C) cycling and hence better capacity and energy density retention. Capacity retention can be defined as the amount of energy accessed during a particular C-rate process such as at C/5, C/2, 1 C or 2 C cycling. Percentage capacity retention or accessible capacity retention is defined as the capacity at a certain C-rate such as C/5, C/2, 1 C or 2 C as a fraction of the capacity at the slow C/5 C-rate cycling condition. In step 206, a cathode slurry solids loading is 65-95%. In step 208, a cathode wet slurry thickness post cathode coating is 210-330 um. In step 210, a cathode dry slurry thickness post oven drying is 150-210 um. In step 212, a cathode thickness post pressing is 100-150 um. In step 214, N:P ratio is 1.05-1.2. Process 200 can be a specified embodiments of process 100.

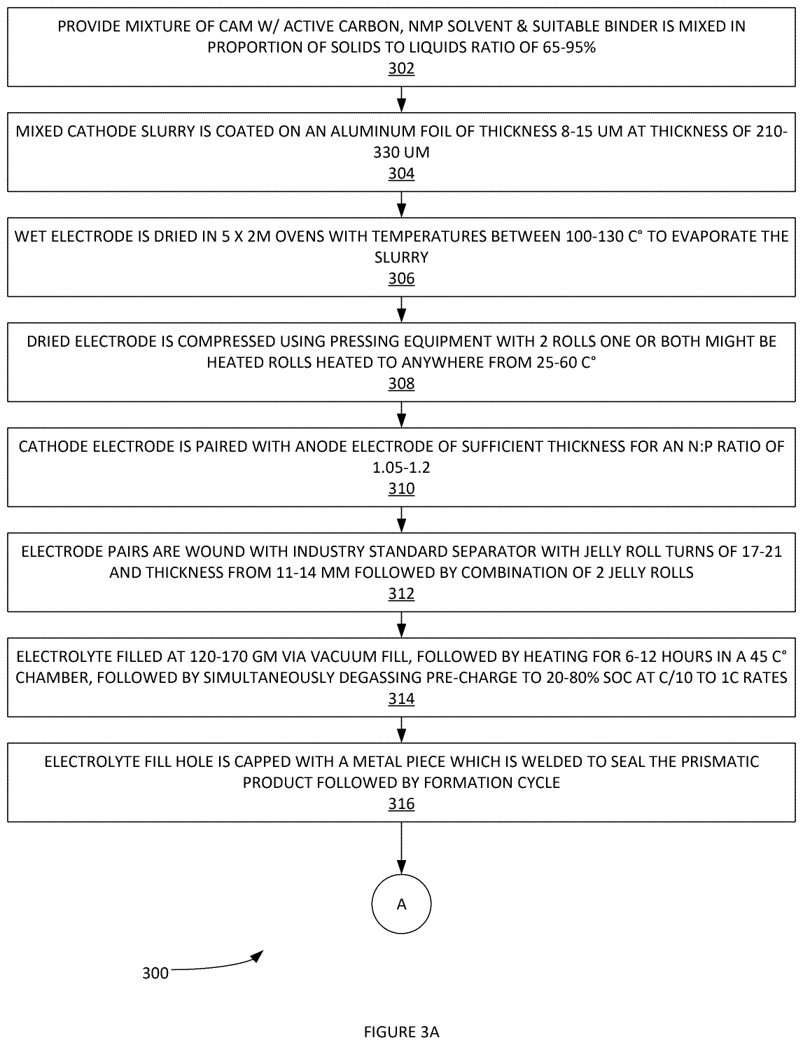

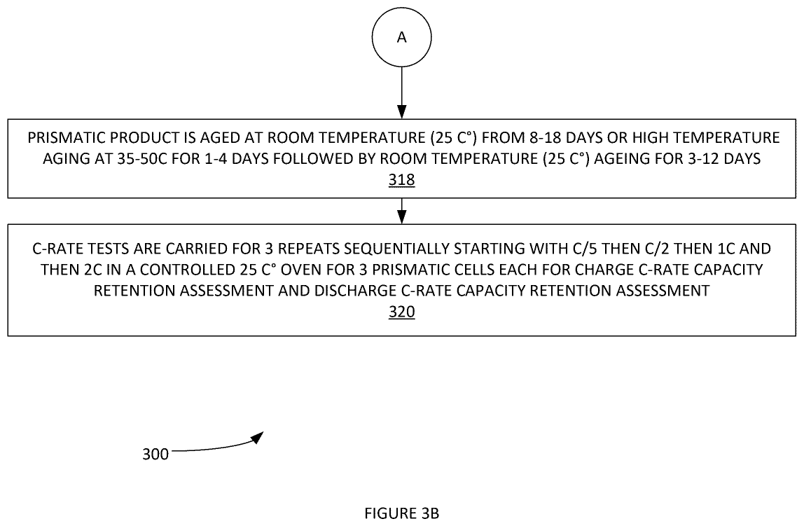

FIGS. 3A-B illustrate an example process 300 for Li ion product for accessible energy density optimization, according to some embodiments. In step 302, process 300 provides a mixture of cathode active material (CAM) with active carbon, NMP solvent and suitable binder is mixed in a proportion of solids to liquids ratio of 65-95%. The mixed cathode slurry is coated on an Aluminum foil of thickness 8-15 um at thickness of 210-330 um in step 304. The wet electrode is dried in 5×2m ovens with temperatures between 100-130° C. to evaporate the slurry in step 306. The dried electrode is compressed using pressing equipment with two (2) rolls one or both might be heated rolls heated to anywhere from 25-60° C. in step 308.

The cathode electrode in one embodiment is paired with anode electrode of sufficient thickness for an N:P ratio of 1.05-1.2 in step 310.

In step 312, the electrode pairs are wound with industry standard separator (e.g. ceramic) or any other with jelly roll turns of 17-21 and thickness from 11-14 mm followed by combination of two (2) jelly rolls connected with current collectors on the cap/lid assembly through ultrasonic or any other welding followed by wrapping in an insulator wrap and the two jelly roll insulator wrapped active material placed in a prismatic can and the cap/lid assembly being welded to the prismatic can via laser welding or any other welding method.

In one embodiment, the electrolyte is filled at 120-170 gm via vacuum fill, followed by heating for 6-12 hours in a 45 C.° chamber, followed by simultaneous pre-charge to 20-80% SOC (State of Charge) at C/10 to 1 C rates while degassing the chemical gases formed by the process in step 314.

The electrolyte fill hole is capped with a metal piece which is welded to seal the prismatic product followed by formation cycle consisting of discharge to 3V, charge to 4.2V and discharge to 3V and charge to anywhere form 20-80% SOC in step 316.

The prismatic product is aged at room temperature (25° C.) from 8-18 days or high temperature aging at 35-50° C. for 1-4 days followed by room temperature (25° C.) ageing for 3-12 days in step 318.

C-rate tests are then carried for 3 repeats sequentially starting with C/5 then C/2 then 1C and then 2C in a controlled 25° C. (Room Temperature) oven for 3 prismatic cells each for charge C-rate capacity retention assessment and discharge C-rate capacity retention assessment in step 320.

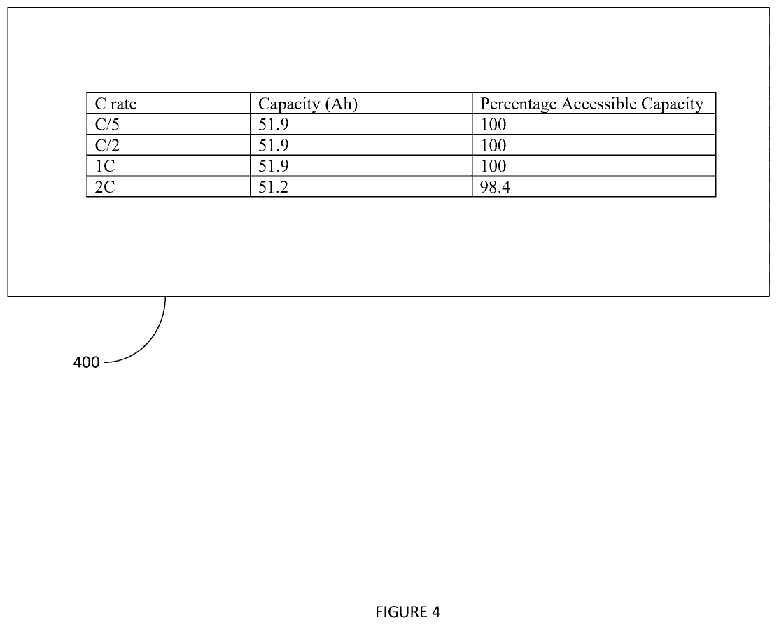

FIG. 4 illustrates an example table 400 showing C-rate behavior for one embodiment at CC-CV charging for different charge rates from 3-4.2V CC followed by 0.05 C current in CV mode, according to some embodiments.

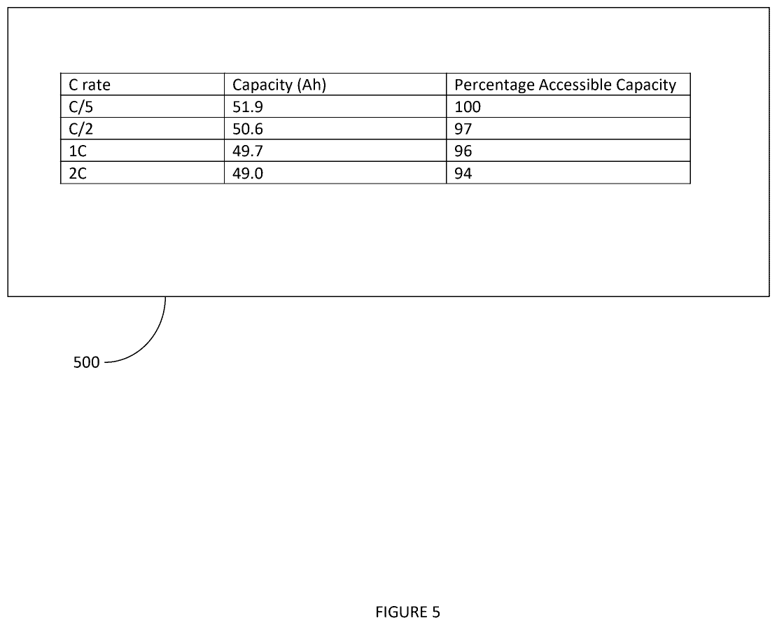

FIG. 5 illustrates an example table 500 showing C-rate behavior for one embodiment at CC discharge for different discharge rates from 4.2-3.0V, according to some embodiments.

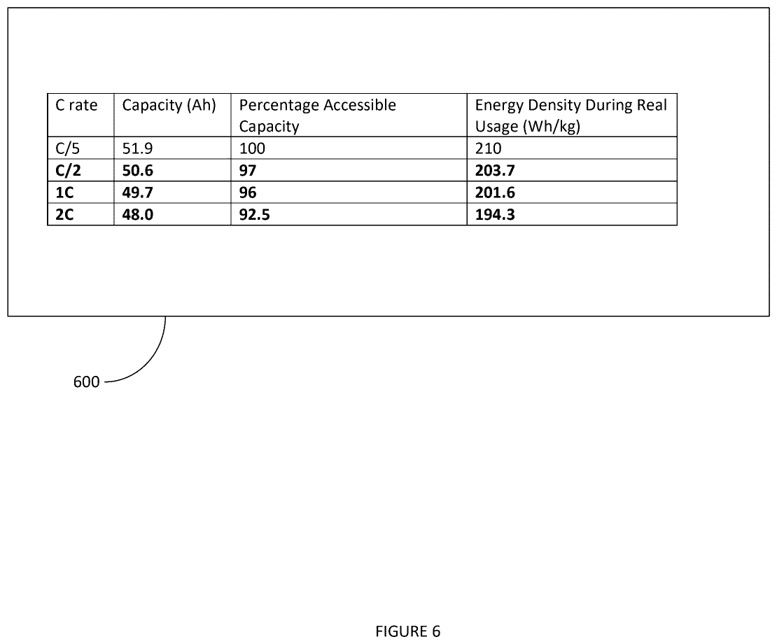

FIG. 6 illustrates an example table 600 showing the accessible energy for standard charge-discharge at different rates with charge at CC-CV charging for different charge rates from 3-4.2V CC followed by 0.05 C current in CV mode and discharge from 4.2-3.0V at different discharge rates, according to some embodiments. Standard rates for mobility for charge and discharge can be 1 C-1 C. The accessible energy at C/2-C/2, 1C-1 C and 2 C-2 C can be higher at 97, 96 and 92.5% from industry standard for most cells of 92%, 85% and 65%. At standard operation of 1 C-1 C there can be 11% extra accessible energy compared to the fundamental slow C-rate (C/5) energy due to design of the prismatic cell components, unit process recipes and flow and final integration of the prismatic or any other Li ion cell form such as cylindrical or pouch (laminated). Example energy density at different C-rates is also specified.

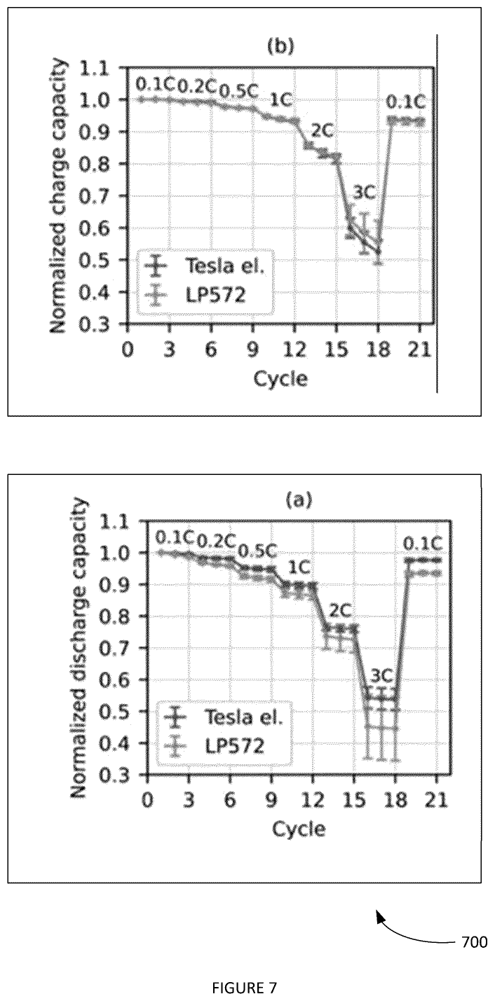

FIG. 7 illustrates an example charge-discharge capacity retention at different C-rates for typical high fundamental energy density (at C/5) NMC/LFP cells, according to some literature publications.

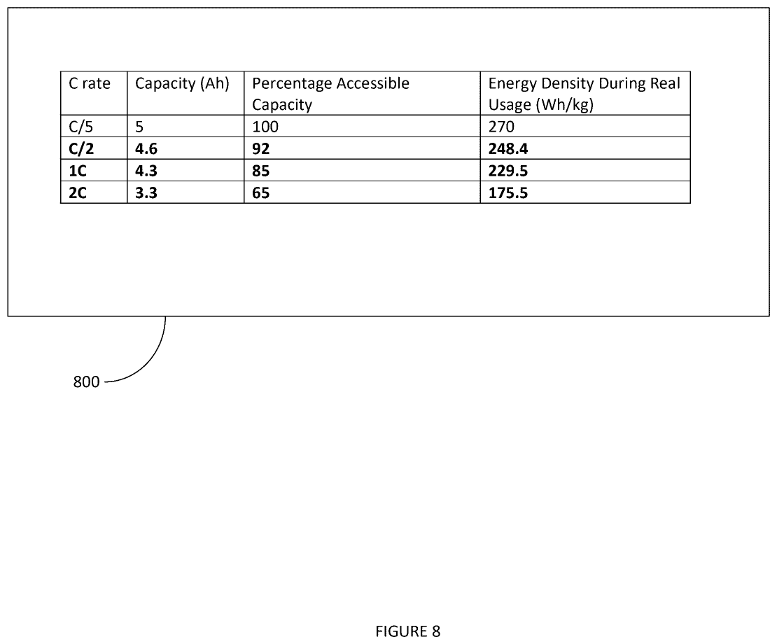

FIG. 8 illustrates an example table 800 showing the accessible energy for standard charge-discharge at different rates with charge at CC-CV charging for different charge rates from 3-4.2V CC followed by 0.05 C current in CV mode and discharge from 4.2-3.0V at different discharge rates for a standard NMC-811 cylindrical 2170 cell.

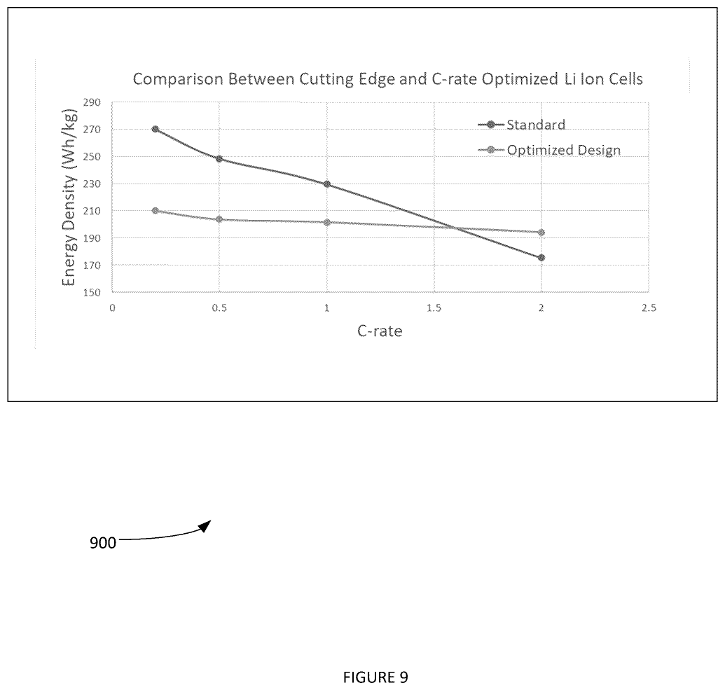

FIG. 9 illustrates an example plot 900 showing the reduction in accessible energy density as C-rate increases, according to some embodiments of optimized Li ion cells compared with standard cutting edge Li ion cells in the market. The C-rate increases are indicative of fast charge-discharge conditions of operating the Li ion cells. Li ion cells optimized for high C-rate performance retain more energy density and can at C-rates >1C very efficiently exhibit high energy densities. As shown, these increases begin to be competitive with cutting edge cells at >1C rates while retaining other characteristics such as less usage of Lithium containing cathode active material, stability and safety of molecules, high temperature performance, cycle life (e.g. number of charge-discharge cycles before the cells lose 20% capacity) and manufacturability (minimized cell-cell variation) and yield in manufacturing.

### CONCLUSION

Although the present embodiments have been described with reference to specific example embodiments, various modifications and changes can be made to these embodiments without departing from the broader spirit and scope of the various embodiments. Accordingly, the specification and drawings are to be regarded in an illustrative rather than a restrictive sense.

What is claimed by this United States patent:

1. A method for Li ion product for accessible energy density optimization, comprising:
providing a cathode active material;
optimizing a cathode aerial density between for a high C-rate energy density retention;
optimizing a cathode thickness during a post pressing for the high C-rate energy capacity and energy density retention;
optimizing an N:P ratio the anode for the high C-rate energy and energy density retention;
optimizing a loading for the high C-rate energy and energy density retention of a cathode mixture slurry solids;
optimizing a cathode electrode wet thickness post coating for the high C-rate energy and energy density retention; and
optimizing a cathode thickness post drying in a coat and a dry oven for the high C-rate energy and energy density retention.

2. The method of claim 1, wherein the cathode active material comprises an NMC-111 material.

3. The method of claim 1, wherein the cathode active material comprises an NMC-532 material.

4. The method of claim 1, wherein the cathode active material comprises an NMC-622 material.

5. The method of claim 1, wherein the cathode active material comprises an NMC-811 material.

6. The method of claim 1, wherein the cathode active material comprises an NMC-9.5.5 material.

7. The method of claim 1, wherein the cathode active material comprises a cathode active material chemistry.

8. The method of claim 7, wherein the cathode active material chemistry comprises an LFP (Lithium Iron Phosphate).

9. The method of claim 7, wherein the cathode active material chemistry comprises an LMFP (Lithium-Manganese-Iron-Phosphate).

10. The method of claim 7, wherein the cathode active material chemistry comprises an LCO (Lithium Cobalt Oxide).

11. The method of claim 7, wherein the cathode active material chemistry comprises an LMnO (Lithium Manganese Oxide).

12. The method of claim 1, wherein the optimizing of the cathode aerial density between for high C-rate energy density retention results in a higher accessible and a useable energy density for the Li ion cell.

13. A method for Li ion product for accessible energy density optimization comprising:
provides a mixture of cathode active material (CAM) with an active carbon, an NMP solvent and a suitable binder such as PVDF (Poly Vinyl Di-Fluoride) is mixed in a proportion of solids to liquids ratio of 65-95%;
coating a mixed cathode slurry is coated on an Aluminum foil of thickness of 8-15 um at thickness of 210-330 um;
drying a wet electrode is dried in a 5×2m oven with a temperatures between 100-130° C. to evaporate the slurry;
compressing the dried electrode using a pressing equipment with two (2) rolls;
pairing the pressed electrode with anode electrode consisting of an arial density and thickness to ensure an N:P ratio of 1.05-1.2; and
winding the electrode pairs with an industry standard separator (e.g. ceramic) or any other with jelly roll turns of 17-21 and thickness from 11-14 mm followed by a combination of two (2) jelly rolls connected with current collectors on a lid assembly through an ultrasonic or any other welding method followed by wrapping in an insulator wrap and the two jelly roll insulator wrapped active material placed in a prismatic can and the lid assembly being welded to the prismatic can via laser welding or any other welding method.

14. The method of claim 13, wherein one or both of the two (2) rolls are heated rolls heated from 25-60° C.

15. The method of claim 13, wherein the electrolyte is filled at 120-170 gm via vacuum fill, followed by heating for 6-12 hours in a 45 C.° chamber, followed by simultaneous pre-charge to 20-80% SOC (State of Charge) at C/10 to 1 C rates while degassing the chemical gases formed.

16. The method of claim 13, wherein the electrolyte fill hole is capped with a metal piece which is welded to seal the prismatic product followed by formation cycle consisting of discharge to 3V, charge to 4.2V and discharge to 3V and charge to anywhere form 20-80% SOC.

17. The method of claim 13, wherein a prismatic product is aged at room temperature (25 C) from 8-18 days or high temperature aging at 35-50° C. for 1-4 days followed by room temperature (25° C.) ageing for 3-12 days.

18. The method of claim 13, wherein a plurality of C-rate tests are then carried for three (3) repeats sequentially starting with C/5 then C/2 then 1 C and then 2 C in a controlled 25° C. oven for 3 prismatic cells each for a charge C-rate capacity retention assessment and a discharge C-rate capacity retention assessment.
